(19) United States
(12) Patent Application Publication
(10) Pub. No.: US 2026/0350321 A1
(43) Pub. Date: Nov. 5, 2026

(54) METHODS AND APPARATUS FOR PROVIDING TRAVEL INFORMATION

(71) Applicants: Hyundai Motor Company, Seoul (KR); Kia Corporation, Seoul (KR)

(72) Inventor: Chang Woo CHUN, Hwaseong-Si (KR)

(73) Assignees: Hyundai Motor Company, Seoul (KR); Kia Corporation, Seoul (KR)

(21) Appl. No.: 19/394,291

(22) Filed: Nov. 19, 2025

(30) Foreign Application Priority Data
Apr. 30, 2025 (KR) 10-2025-0056964

(51) Int. Cl. G06F 40/40; G06F 40/289

(52) U.S. Cl. CPC G06F 40/40; G06F 40/289

(57) ABSTRACT

A method includes obtaining conversation history of users; storing the conversation history by classifying the conversation history for each user; generating travel information by using one or more language models, based on the conversation history; and outputting the travel information.

### CROSS-REFERENCE TO RELATED APPLICATION

The present application claims the benefit of and priority to Korean Patent Application No. 10-2025-0056964, filed on Apr. 30, 2025, the entire disclosure of which is incorporated herein by reference in its entirety.

### BACKGROUND OF THE PRESENT DISCLOSURE

### Field of the Present Disclosure

The present disclosure relates to methods and an apparatus for providing travel information.

### Description of Related Art

The statements in the present section merely provide background information related to the present disclosure and do not necessarily form related art.

Recently, AI technology and user interface technology utilizing voice recognition systems in vehicles have rapidly been developed. In particular, technology that analyzes natural language data input by users as voice and provides travel information customized to user needs plays an important role in greatly improving user experiences in vehicle environments. The present technology has been utilized to provide users with various forms of travel information, such as route guidance, destination information, tourist attraction recommendations, and real-time traffic information.

However, in many cases, existing methods for providing travel information are limited to services inside vehicles. For example, travel information disposed through a vehicle navigation system or an infotainment system is only valid when the user is located inside the vehicle, and there is a problem in that the travel information is less likely to be continuously provided when the user leaves the vehicle. That is, after the user leaves the vehicle, there is a limitation that the user cannot continuously maintain access ability to the travel information provided inside the vehicle.

Therefore, it is desirable to provide methods and an apparatus which can continuously provide information to users through mobile devices of the users even after the users leave their vehicles.

### BRIEF SUMMARY

According to various aspects of the present disclosure, the present disclosure provides a method, the method, including: obtaining conversation history of users; storing the conversation history by classifying the conversation history for each user; generating travel information by using one or more language models, based on the conversation history; and outputting the travel information.

According to various aspects of the present disclosure, the present disclosure provides an apparatus, the apparatus for providing travel information, including: at least one memory storing commands; and at least one processor, wherein the at least one processor executes the commands to execute: obtaining conversation history of users, storing the conversation history by classifying the conversation history for each user, generating travel information by using one or more language models, based on the conversation history, and outputting the travel information.

### BRIEF DESCRIPTION OF THE DRAWINGS

FIG. 1 is a block diagram schematically illustrating configurations of an apparatus for providing travel information and a peripheral device thereof according to an exemplary embodiment of the present disclosure.

FIG. 2 is a reference view for describing a terminal disposed in a vehicle and a mobile device possessed by each user inside the vehicle according to an exemplary embodiment of the present disclosure.

FIG. 3 is a flowchart schematically illustrating a method for providing travel information by using a terminal inside a vehicle according to an exemplary embodiment of the present disclosure.

FIG. 4 is a flowchart schematically illustrating a method for providing travel information by using a mobile device inside a vehicle according to an exemplary embodiment of the present disclosure.

FIG. 5A is a flowchart schematically illustrating a method for providing travel information by using a mobile device outside a vehicle according to an exemplary embodiment of the present disclosure.

FIG. 5B is a flowchart schematically illustrating a method for providing travel information by using a mobile device outside a vehicle according to an exemplary embodiment of the present disclosure.

FIG. 6 is a flowchart schematically illustrating a method for providing travel information according to an exemplary embodiment of the present disclosure.

FIG. 7 is a block diagram schematically illustrating an exemplary computing device that may be used to implement the apparatus and the method which are described in the present disclosure.

### DETAILED DESCRIPTION

The present disclosure mainly aims to provide methods and an apparatus for providing travel information. Specifically, the present disclosure mainly aims to provide methods and an apparatus in which a user may be continuously provided with travel information provided while the user is located inside the vehicle even after the user leaves the vehicle, and furthermore, which may provide travel information generated in view of both conversation history acquired while the user is located inside the vehicle and conversation history acquired after the user leaves the vehicle.

Aspects to be achieved by the present disclosure are not limited to the above-described aspects, and other aspects not described herein will be clearly understood by those skilled in the art, from the description below.

Hereinafter, various exemplary embodiments of the present disclosure will be described in detail with reference to the accompanying drawings. In the following description, like reference numerals designate like elements, although the elements are shown in different drawings. Furthermore, the following description of various exemplary embodiments will omit for the purpose of clarity and for brevity, a detailed description of related known components and functions when considered to obscure the subject of the present disclosure.

Various ordinal numbers or alpha codes, such as first, second, i), ii), a), b), etc., are prefixed solely to differentiate one component from the other but not to imply or suggest the substances, order, or sequence of the components. Throughout the present specification, when a part ‘includes’ or ‘comprises’ a component, the part is meant to further include other components, to not exclude thereof unless specifically stated to the contrary.

The following detailed description, along with the accompanying drawings, is intended to illustrate exemplary embodiments of the present disclosure and is not intended to represent the only embodiments in which the present disclosure may be practiced.

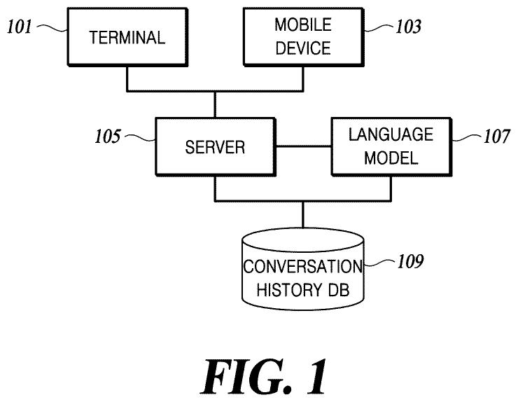

FIG. 1 is a diagram schematically illustrating the configuration of an apparatus for providing travel information and its peripheral devices according to an exemplary embodiment of the present disclosure.

Referring to FIG. 1, an apparatus for providing the travel information may include a terminal 101, a mobile device 103, a server 105, a language model 107, and conversation history DB 109.

The terminal 101 may be a device disposed in a vehicle. The terminal 101 may be implemented by using a portable device such as a smartphone, a tablet, a smartwatch, or a wearable device. The terminal 101 may include various sensors, a communication module, and a user interface, and may receive an input from a user, or may exchange data with an external device. The terminal 101 may communicate with an external server through a network to obtain or provide various information.

The terminal 101 may obtain conversation history from a user. The terminal 101 may obtain an utterance of the user, that is, natural language data, by using a voice recognition system. The terminal 101 may obtain the natural language data by using a user input device. The natural language data may have a form of text. The user input device may include a display, a touch screen, a keyboard, or a button. The terminal 101 may convert content input by the user in a form of voice into text by using the voice recognition system. The terminal 101 may directly receive the content input by the user in a form of text by using the user input device.

The terminal 101 may provide the user with travel information. The terminal 101 may visually and/or audibly transmit the travel information by using a display and a sound system. For example, the terminal 101 may provide the user with a current location, destination information, a route guidance, and tourist attraction information.

The mobile device 103 may be possessed by the user. The mobile device 103 may be implemented by using a portable device such as a smartphone, a tablet, a smartwatch, or a wearable device. The mobile device 103 may include various sensors, a communication module, and a user interface, and may receive an input from the user, or may exchange data with an external device. The mobile device 103 may communicate with an external server through a network to obtain or provide various information.

The mobile device 103 may obtain the conversation history from the user. The mobile device 103 may obtain an utterance of the user, that is, natural language data, by using a voice recognition system. The mobile device 103 may obtain the natural language data by using a user input device. The natural language data may have a form of text. The user input device may include a keyboard that appears on a display of the mobile device 103. The mobile device 103 may convert content input by the user in a form of voice form into text by using the voice recognition system. The mobile device 103 may directly receive the content input by the user in a form of the text by using the user input device.

The mobile device 103 may provide the user with the travel information. The mobile device 103 may visually and/or audibly transmit the travel information by using a display and a sound system. For example, the mobile device 103 may provide the user with a current location, destination information, a route guidance, and tourist attraction information.

The server 105 may be connected to the terminal 101 or the mobile device 103. The server 105 may include a vehicle-to-roadside server (VR server) 301 and an application server 303. The VR server 301 and the application server 303 may communicate with each other through a network. The VR server 301 may communicate with the terminal 101, and the application server 303 may communicate with the mobile device 103. Each of the server 105, the VR server 301, and the application server 303 may be implemented by partially or entirely using one or more computing devices 70.

The server 105 may store the conversation history in the conversation history DB 109. The server 105 may store the conversation history by dividing classifying the conversation history for each user. The conversation history may include at least one of common conversation history or individual conversation history. In a case of the common conversation history, the server 105 may equally store the common conversation history in respective storage spaces allocated to the respective users. In a case of the individual conversation history, the server 105 may store the individual conversation history only in a storage space allocated to the user generating the individual conversation history. Hereinafter, a more detailed method by which the server 105 stores the common conversation history or the individual conversation history for each user will be described with reference to Table 1 and Table 2.

The language model 107 may be configured to generate the travel information, based on the conversation history. The conversation history may be obtained by using the terminal 101 or the mobile device 103. The language model 107 may retrieve the conversation history from the conversation history DB 109. The language model 107 may be implemented by using a large language model (LLM). The large language model may be a generative language model. The generative language model is an artificial intelligence model trained in advance with a large amount of text data, may analyze the natural language data input from the user, and may be configured to generate a response suitable for the input. In an exemplary embodiment of the present disclosure, the natural language data input from the user may be expressed as conversation history. For example, the generative language model may analyze conversation content input from the user to identify information on a visiting destination of the user, an exemplary route, and a travel style, and may be configured to generate and provide an answer, based on analyzed content. That is, the language model 107 may analyze the conversation history to identify the information on the visiting destination of the user, the exemplary route, and the travel style, and may be configured to generate and provide the travel information, based on the analyzed content. The language model 107 may be implemented by partially or entirely using one or more computing devices 70.

The conversation history DB 109 may be a database configured for storing the conversation history. The server 105 and the language model 107 may access the conversation history DB 109. The server 105 has read/write access to the conversation history DB 109, and may store the obtained conversation history in the conversation history DB 109, or may retrieve the obtained conversation history when necessary. The language model 107 has read access to the conversation history DB 109, may retrieve the conversation history stored in the conversation history DB 109, and may be configured to generate information, based on the conversation history. For example, the language model 107 may be configured to generate the travel information, based on the conversation history stored in the conversation history DB 109, and may provide the user with the travel information. The conversation history DB 109 may be implemented by partially or entirely using one or more computing devices 70.

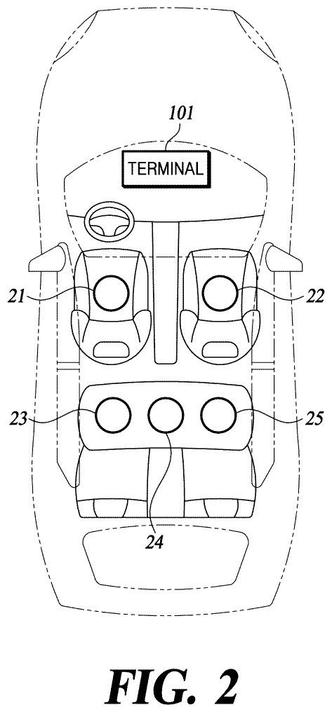

FIG. 2 is a reference view for describing the terminal disposed in the vehicle and the mobile device possessed by each user inside the vehicle according to an exemplary embodiment of the present disclosure.

Referring to FIG. 2, the terminal 101 may be disposed in the vehicle. The terminal 101 may obtain the conversation history when the users are located inside the vehicle, and may output the travel information to the users located inside the vehicle.

Each of the users located inside the vehicle may possess an individual mobile device. Based on locations of the respective users inside the vehicle, the mobile device 103 may be classified into a first mobile device 21, a second mobile device 22, a third mobile device 23, a fourth mobile device 24, and a fifth mobile device 25. That is, the mobile device 103 may include the first mobile device 21, the second mobile device 22, the third mobile device 23, the fourth mobile device 24, and the fifth mobile device 25. In other words, the first mobile device 21, the second mobile device 22, the third mobile device 23, the fourth mobile device 24, and the fifth mobile device 25 may be collectively referred to as the mobile device 103.

The users may carry the mobile device 103 outside the vehicle. That is, the mobile device 103 may be separated from the vehicle, unlike the terminal 101.

The mobile device 103 may obtain the conversation history when the users are located inside the vehicle, and may obtain the conversation history even when the users are not located inside the vehicle. The mobile device 103 may output the travel information to the users who are located inside the vehicle, and may also output the travel information to the users who are not located inside the vehicle.

The conversation history may include at least one of common conversation history or an individual conversation history. The common conversation history may be conversation history obtained when the users are located inside the vehicle. The individual conversation history may be conversation history obtained when the users are not located inside the vehicle. The terminal 101 may obtain the common conversation history. The mobile device 103 may obtain the common conversation history and the individual conversation history. In other words, the common conversation history may be obtained by using the terminal 101 or the mobile device 103, and the individual conversation history may be obtained by using the mobile device 103.

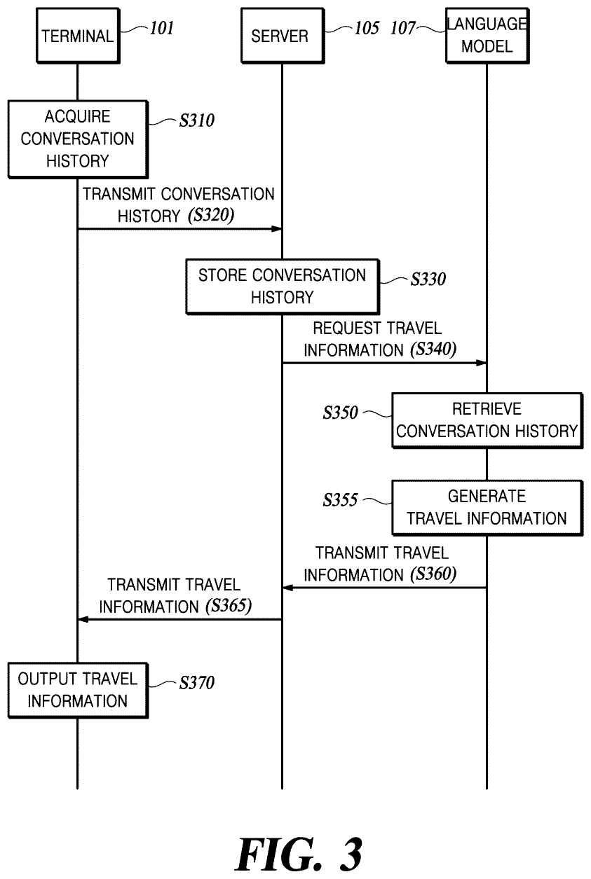

FIG. 3 is a flowchart schematically illustrating a method for providing the travel information by using the terminal inside the vehicle according to an exemplary embodiment of the present disclosure.

Referring to FIG. 3, the terminal 101 may obtain the conversation history (S310). The conversation history may be common conversation history. The users may not be located inside the vehicle.

The terminal 101 may transmit the conversation history to the server 105 (S320). The conversation history may be the common conversation history.

The server 105 may store the conversation history (S330). The server 105 may store the conversation history in conversation history DB 109. The conversation history may be the common conversation history. The server 105 may store the conversation history by classifying the conversation history for each user. The server 105 may equally store common conversation history in respective storage spaces allocated to the respective users.

TABLE 1

| UNIQUE | CONVERSATION |
|---|---|
| NUMBER | HISTORY |
| 1001 | Data 1 |
| 1002 | Data 1 |
| 1003 | Data 1 |
| 1004 | Data 1 |
| 1005 | Data 1 |

Table 1 shows an example in which the common conversation history is classified and stored for each user in the conversation history DB 109. Referring to Table 1, a unique number for each user is listed. The unique number for each user may be a sum of a vehicle number and a user number. The vehicle number may be a vehicle identification number (VIN). The user number may be determined based on a seat position inside the vehicle in which the user is located. For example, in FIG. 2, the unique number of a first user possessing the first mobile device 21 may be ‘1001’ obtained by adding the vehicle number 1000 and the user number 1. As an exemplary embodiment of the present disclosure, in FIG. 2, the unique number of a second user possessing the second mobile device 22 may be ‘1002’ obtained by adding the vehicle number 1000 and the user number 2.

Referring to Table 1, all conversation history are equally represented as ‘Data 1’. ‘Data 1’ may be the common conversation history. The server 105 may store ‘Data 1’ which is the common conversation history, in a separate storage space corresponding to the unique number of each user. The server 105 may equally store the common conversation history for each of the first user (unique number 1001), the second user (unique number 1002), the third user (unique number 1003), the fourth user (unique number 1004), and the fifth user (unique number 1005). In other words, the common conversation history may be equally stored in respective storage spaces allocated to the respective users.

The server 105 may request the travel information from the language model 107 (S340). The conversation history may include keywords related to a travel information request. For example, when the conversation history includes “What exists around Haevichi Hotel?”, the server 105 may recognize the “Haevichi Hotel” as a keyword, and may request the travel information from the language model 107.

The language model 107 may retrieve the conversation history (S350). The language model 107 may retrieve the conversation history stored in the conversation history DB 109. The conversation history may be the common conversation history.

The language model 107 may be configured to generate the travel information (S355). The language model 107 may be configured to generate the travel information, based on the conversation history. The conversation history may be the common conversation history. For example, when the common conversation history includes “What exists around Haevichi Hotel?”, the language model 107 may be configured to generate the travel information including information on one or more of Jeju Folk Village, Seopjikoji, Jeju Herb Dongsan, Aqua Planet Jeju, and Pyoseon Beach.

The language model 107 may transmit the travel information to the server 105 (S360). The server 105 may transmit the travel information to the terminal 101 (S365). The travel information may be generated, based on the common conversation history.

The terminal 101 may output the travel information (S370). The terminal 101 may output the travel information to the users by using a display or an audio system. The users may be located inside the vehicle. For example, the terminal 101 may use the audio system to output voice information, such as “Jeju Folk Village is located within a walking distance around Haevichi Hotel & Resort, and Seopjikoji and Jeju Herb Dongsan are located within a 15-minute drive. Aqua Planet Jeju is a popular place to visit with children. Pyoseon Beach is also a popular place to visit during the summer, but Pyoseon Beach is not recommended today because the weather is very windy and chilly”. The users may obtain the travel information output from the terminal 101 in a form of voice. The same travel information may be provided to the respective users, and each user may obtain the travel information by using a common device. In the present way, an apparatus for providing the travel information according to an exemplary embodiment of the present disclosure may provide a customized travel guide to the users so that the travel information generated based on the common conversation history obtained from the users located inside the vehicle is output to the users by using the terminal disposed in the vehicle.

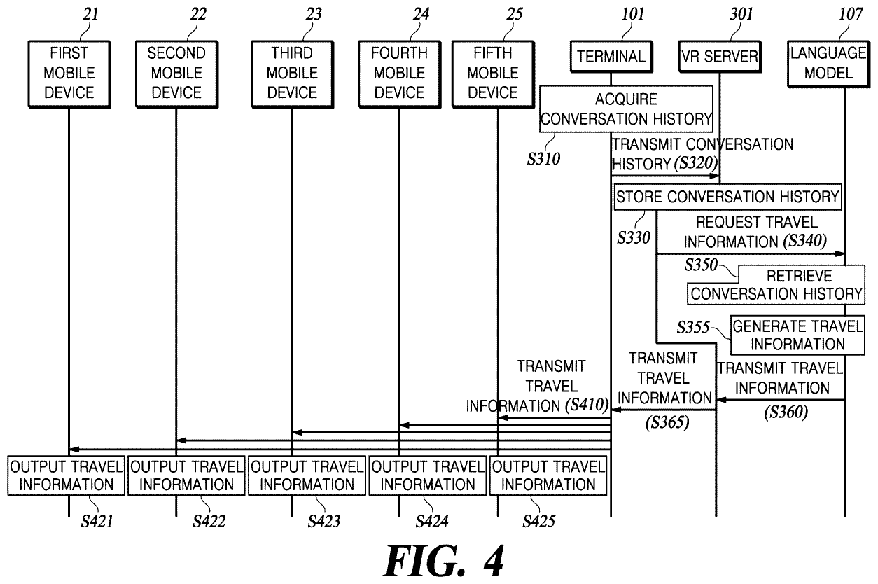

FIG. 4 is a flowchart schematically illustrating a method for providing the travel information by using the mobile device inside the vehicle according to an exemplary embodiment of the present disclosure.

Referring to FIG. 4, processes in S410 to S425 are added compared to FIG. 3. Processes in S310 to S365 in FIG. 4 are the same as those in FIG. 3 except that some or all of the processes which can be performed by the server 105 may be performed by the VR server 301. Therefore, hereinafter, processes in S310 to S365 including repeated configurations in FIG. 3 will be omitted.

Referring to FIG. 4, the terminal 101 may transmit the travel information to the respective mobile devices (21, 22, 23, 24, and 25) (S410). That is, the terminal 101 may transmit the travel information to each of the first mobile device 21, the second mobile device 22, the third mobile device 23, the fourth mobile device 24, and the fifth mobile device 25. The travel information may be generated based on the common conversation history. The travel information transmitted to each of the first mobile device 21 to the fifth mobile device 25 may be the same travel information.

According to an exemplary embodiment of the present disclosure, the users may be located inside the vehicle. Each of the mobile devices 21, 22, 23, 24, and 25 may output the travel information. The first mobile device 21 may output the travel information (S421). The second mobile device 22 may output the travel information (S422). The third mobile device 23 may output the travel information (S423). The fourth mobile device 24 may output the travel information (S424). The fifth mobile device 25 may output the travel information (S425). Each of the mobile devices may output the travel information to each of the users by using the display or the audio system. For example, each of the first mobile device 21, the second mobile device 22, the third mobile device 23, the fourth mobile device 24, and the fifth mobile device 25 may use the audio system in each of the mobile devices to output voice information, such as “Jeju Folk Village is located within a walking distance around Haevichi Hotel & Resort, and Seopjikoji and Jeju Herb Dongsan are located within a 15-minute drive. Aqua Planet Jeju is a popular place to visit with children. Pyoseon Beach is also a popular place to visit during the summer, but Pyoseon Beach is not recommended today because the weather is very windy and chilly”. The respective users may obtain the travel information output from the respective mobile devices in a form of voice. The same travel information may be provided to the respective users, and the respective users may obtain the travel information by using separate devices. For example, the users may listen to the travel information by using earphones connected to the respective mobile devices. In the present way, the apparatus for providing the travel information according to an exemplary embodiment of the present disclosure may provide a customized travel guide to the users so that travel information generated based on the common conversation history obtained from the users located inside vehicles is output to the respective users by using the mobile devices possessed by the respective users.

According to another exemplary embodiment of the present disclosure, the users may not be located inside the vehicle. For example, the users may leave the vehicle, and may wander around a nearby area. The users may carry their respective mobile devices outside the vehicle, and may individually travel the nearby area. Each of the mobile devices 21, 22, 23, 24, and 25 may be connected to the terminal 101 by using Bluetooth pairing. Each of the mobile devices may output the travel information. The first mobile device 21 may output the travel information (S421). The second mobile device 22 may output the travel information (S422). The third mobile device 23 may output the travel information (S423). The fourth mobile device 24 may output the travel information (S424). The fifth mobile device 25 may output the travel information (S425). Each of the mobile devices may output the travel information to each user by using the display or the audio system. For example, each of the first mobile device 21, the second mobile device 22, the third mobile device 23, the fourth mobile device 24, and the fifth mobile device 25 may use the audio system in each of the mobile devices to output voice information, such as “Jeju Folk Village is located within a walking distance around Haevichi Hotel & Resort, and Seopjikoji and Jeju Herb Dongsan are located within a 15-minute drive. Aqua Planet Jeju is a popular place to visit with children. Pyoseon Beach is also a popular place to visit during the summer, but Pyoseon Beach is not recommended today because the weather is very windy and chilly”. The respective users may obtain the travel information output from the respective mobile devices in a form of voice. The same travel information may be provided to the respective users, and the respective users may obtain the travel information by using separate devices. For example, the users may listen to the travel information by using earphones connected to the respective mobile devices. In the present way, the apparatus for providing the travel information according to an exemplary embodiment of the present disclosure may continuously provide a travel guide to the users so that the travel information generated based on the common conversation history obtained from the users located inside the vehicle is output to the respective users by using the mobile devices possessed by the respective users even after the users leave the vehicle. In the present way, the apparatus for providing the travel information according to an exemplary embodiment of the present disclosure may naturally shift a vehicle-based service to a mobile-based service by continuously providing the travel information provided to the users inside the vehicle even when the users are located outside the vehicle.

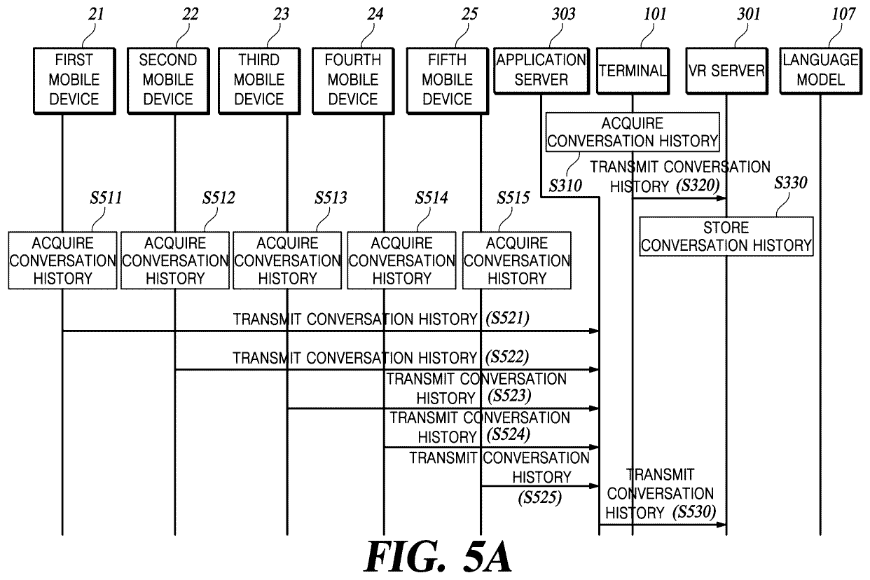

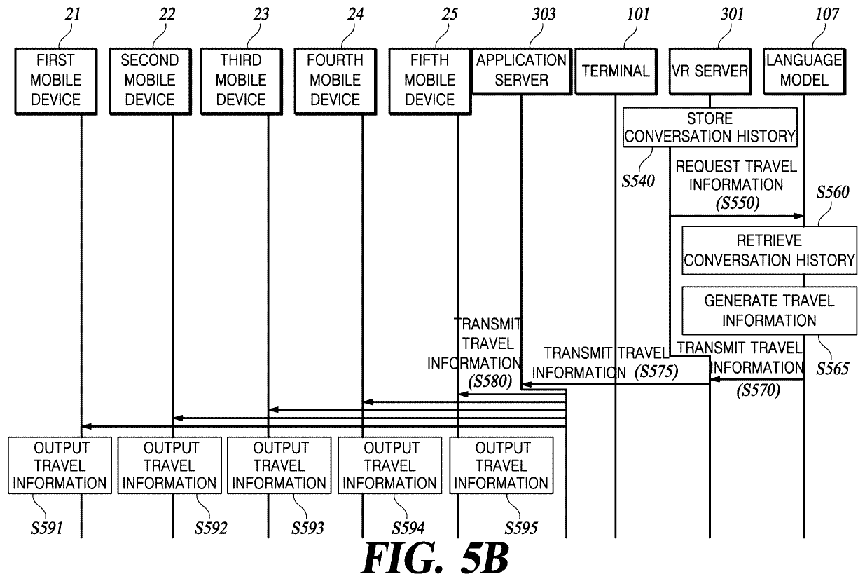

FIG. 5A is a flowchart schematically illustrating a method for providing the travel information by using the mobile device outside the vehicle according to an exemplary embodiment of the present disclosure.

FIG. 5B is a flowchart schematically illustrating a method for providing the travel information by using the mobile device outside the vehicle according to an exemplary embodiment of the present disclosure.

Referring to FIG. 5A and FIG. 5B, processes in S340 to S370 are removed, and processes in S511 to S595 are added compared to FIG. 3. Processes in S310 to S330 in FIG. 5A are the same as those in FIG. 3 except that some or all of the processes which can be performed by the server 105 may be performed by the VR server 301. Therefore, hereinafter, processes in S310 to S330 including repeated configurations in FIG. 3 will be omitted.

While processes in S310 to S330 are performed, the users may be located inside the vehicle. The conversation history stored in the conversation history DB 109 in the process S330 may be the common conversation history.

Referring to FIG. 5A, each of the mobile devices 21, 22, 23, 24, and 25 may obtain the conversation history. The first mobile device 21 may obtain the conversation history (S511). The second mobile device 22 may obtain the conversation history (S512). The third mobile device 23 may obtain the conversation history (S513). The fourth mobile device 24 may obtain the conversation history (S514). The fifth mobile device 25 may obtain the conversation history (S515). The conversation history may be the individual conversation history. The users may not be located inside the vehicle.

Each of the mobile devices 21, 22, 23, 24, and 25 may transmit the conversation history to the application server 303. The first mobile device 21 may transmit the conversation history (S521). The second mobile device 22 may transmit the conversation history (S522). The third mobile device 23 may transmit the conversation history (S523). The fourth mobile device 24 may transmit the conversation history (S524). The fifth mobile device 25 may transmit the conversation history (S525). The conversation history may be the individual conversation history.

The application server 303 may transmit the conversation history to the VR server 301 (S530). The conversation history may be the individual conversation history obtained from each of the mobile devices 21, 22, 23, 24, and 25.

Referring to FIG. 5B, the VR server 301 may store the conversation history (S540). The VR server 301 may store the conversation history in the conversation history DB 109. The conversation history stored in the conversation history DB 109 may be the individual conversation history. The VR server 301 may store the conversation history by classifying the conversation history for each user. The VR server 301 may store the individual conversation history only in the storage space allocated to the user generating the individual conversation history.

TABLE 2

| UNIQUE | CONVERSATION |
|---|---|
| NUMBER | HISTORY |
| 1001 | Data 11 |
| 1002 | Data 12 |
| 1003 | Data 13 |
| 1004 | Data 14 |
| 1005 | Data 15 |

Table 2 shows an example in which the individual conversation history is classified and stored for each user in the conversation history DB 109. Referring to Table 2, the unique number for each user is listed. The unique number for each user may be the sum of the vehicle number and the user number. The vehicle number and the user number have been described in detail in Table 1. Therefore, repeated description will be omitted here.

Referring to Table 2, the conversation history is displayed differently for each user, such as ‘Data 11’, ‘Data 12’, ‘Data 13’, ‘Data 14’, and ‘Data 15’. Each of ‘Data 11’, ‘Data 12’, ‘Data 13’, ‘Data 14’, and ‘Data 15’ may be the individual conversation history. The VR server 301 may separately store the individual conversation history as ‘Data 11’, ‘Data 12’, ‘Data 13’, ‘Data 14’, and ‘Data 15’ in a separate storage space corresponding to the unique number of each user. The VR server 301 may store each individual conversation history only in a storage space corresponding to the unique number of the user generating the individual conversation history. The VR server 301 may store the individual conversation history ‘Data 11’ only in the storage space allocated to the first user (unique number 1001). The VR server 301 may store individual conversation history ‘Data 12’ only in the storage space allocated to the second user (unique number 1002). The VR server 301 may store individual conversation history ‘Data 13’ only in the storage space allocated to the third user (unique number 1003). The VR server 301 may store individual conversation history ‘Data 14’ only in the storage space allocated to the fourth user (unique number 1004). The VR server 301 may store individual conversation history ‘Data 15’ only in the storage space allocated to the fifth user (unique number 1005). That is, the individual conversation history may be separately stored only in the storage space allocated to the user generating the individual conversation history, out of the storage spaces allocated to the respective users. In other words, the individual conversation history may be differently stored for each user.

TABLE 3

| UNIQUE | CONVERSATION |
|---|---|
| NUMBER | HISTORY |
| 1001 | Data 1, Data 11 |
| 1002 | Data 1, Data 12 |
| 1003 | Data 1, Data 13 |
| 1004 | Data 1, Data 14 |
| 1005 | Data 1, Data 15 |

Table 3 shows an example in which the common conversation history and the individual conversation history are stored for each user in the conversation history DB 109. As a result of performing processes in S330 and S540, the conversation history may be stored in the conversation history DB 109 as shown in Table 3. For example, common conversation history ‘Data 1’ and individual conversation history ‘Data 11’ may be stored in the storage space allocated to the first user (unique number 1001).

The VR server 301 may request the travel information from the language model 107 (S550). The conversation history may include keywords related to the travel information request. The common conversation history and/or the individual conversation history may include keywords related to the travel information request. For example, when the common conversation history includes “What exists around Haevichi Hotel?”, the VR server 301 may recognize “Haevichi Hotel” as a keyword, and may request the travel information from the language model 107. For example, when the individual conversation history includes “How about Aqua Planet?”, the VR server 301 may recognize “Aqua Planet” as a keyword, and may request the travel information from the language model 107.

The language model 107 may retrieve the conversation history (560). The language model 107 may retrieve the conversation history stored in the conversation history DB 109. The language model 107 may retrieve the conversation history stored in the conversation history DB 109 for each user. The conversation history may be the common conversation history and the individual conversation history. For example, the language model 107 may retrieve common conversation history ‘Data 1’ and individual conversation history ‘Data 11’ for the first user. As an exemplary embodiment of the present disclosure, the language model 107 may retrieve common conversation history ‘Data 1’ and individual conversation history ‘Data 12’ for the second user.

The language model 107 may be configured to generate the travel information (S565). The language model 107 may be configured to generate the travel information, based on the conversation history. The conversation history may be the common conversation history and the individual conversation history. The language model 107 may be configured to generate the travel information for each user. For example, when the common conversation history includes “What exists around Haevichi Hotel?” and the individual conversation history for the first user includes “How about Aqua Planet?”, the language model 107 may be configured to generate the travel information for the first user, including information on one or more of Jeju Folk Village, Seopjikoji, Jeju Herb Dongsan, and Pyoseon Beach, and information on Aqua Planet Jeju. As an exemplary embodiment of the present disclosure, when the common conversation history includes “What exists around Haevichi Hotel?” and the individual conversation history for the second user includes “How about Jeju Herb Dongsan?”, the language model 107 may be configured to generate the travel information for the second user, including information on one or more of Jeju Folk Village, Seopjikoji, Aqua Planet Jeju, and Pyoseon Beach, and information on Jeju Herb Dongsan.

The language model 107 may transmit the travel information to the VR server 301 (S570). The VR server 301 may transmit the travel information to the application server 303 (S575). The application server 303 may transmit the travel information to the respective mobile devices 21, 22, 23, 24, and 25 (S580). That is, the application server 303 may transmit the travel information to each of the first mobile device 21, the second mobile device 22, the third mobile device 23, the fourth mobile device 24, and the fifth mobile device 25. The travel information may be generated based on the common conversation history and the individual conversation history. The travel information transmitted to the respective first mobile device 21 to the fifth mobile device 25 may be different travel information.

The users may not be located inside the vehicle. For example, the users may leave the vehicle, and may wander around a nearby area. The users may carry their respective mobile devices outside the vehicle, and may individually travel the nearby area. Each of the mobile device 21, 22, 23, 24, and 25 may be connected to the application server 303 by using network communication.

Each of the mobile devices may output the travel information. The first mobile device 21 may output the travel information (S591). The second mobile device 22 may output the travel information (S592). The third mobile device 23 may output the travel information (S593). The fourth mobile device 24 may output the travel information (S594). The fifth mobile device 25 may output the travel information (S595). Each of the mobile devices may output the travel information to each user by using the display or the audio system. The travel information may be different for each user. Each of the mobile devices may output the travel information for each user. The travel information for each user may be generated based on the common conversation history and the individual conversation history for the user. For example, the travel information for the first mobile device 21 may be generated based on the common conversation history “What exists around Haevichi Hotel?” and the individual conversation history “How about Aqua Planet?” The first mobile device 21 may use the audio system to output voice information, such as “Jeju Folk Village is located within a walking distance around Haevichi Hotel & Resort, and Seopjikoji and Jeju Herb Dongsan are located within a 15-minute drive. Aqua Planet Jeju is a popular place to visit with children. Pyoseon Beach is also a popular place to visit during the summer, but Pyoseon Beach is not recommended today because the weather is very windy and chilly. Aqua Planet Jeju is open from 10:00 AM to 6:00 PM on weekdays and weekends, and is closed on public holidays. Aqua Planet Jeju is the largest aquarium in Korea, boasting an average of 5,000 visitors per year. Aqua Planet Jeju recently becomes popular on a social network service (SNS) thanks to videos of a white dolphin called Beluga.” As an exemplary embodiment of the present disclosure, the travel information may be generated for the second mobile device 22, based on the common conversation history “What exists around Haevichi Hotel?” and “How about Jeju Herb Garden?” The second mobile device 22 may use the audio system to output voice information, such as “Jeju Folk Village is located within a walking distance around Haevichi Hotel & Resort, and Seopjikoji and Jeju Herb Garden are located within a 15-minute drive. Aqua Planet Jeju is a popular place to visit with children. Pyoseon Beach is also a popular place to visit during the summer, but Pyoseon Beach is not recommended today because the weather is windy and chilly. Jeju Herb Garden is open from 9:00 AM to 5:00 PM on weekdays and weekends. However, the closing time may vary in accordance with the season. Jeju Herb Garden is divided into an outdoor space and an indoor space. In the indoor greenhouse, various plants as well as herbs are grown. Jeju Herb Dongsan operates a green tea picking experience program, which is popular with family visitors.” The users may obtain the travel information output from the respective mobile devices in a form of voice. The travel information provided to the respective users may be different, and the respective users may obtain the travel information by using separate devices. For example, the users may listen to the travel information by using earphones connected to the respective mobile devices. In the present way, the apparatus for providing the travel information according to an exemplary embodiment of the present disclosure may continuously provide a customized travel guide to the users by outputting user-specific travel information generated based on the common conversation history obtained from the users located inside vehicle and the individual conversation history obtained from the respective users who are not located inside the vehicle to the respective users by using the mobile devices possessed by the users even after the users leave the vehicle.

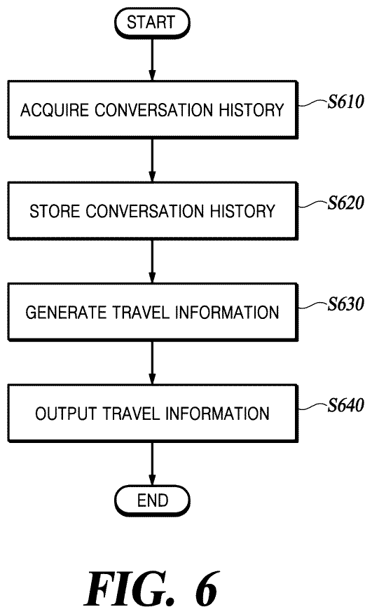

FIG. 6 is a flowchart schematically illustrating a method for providing the travel information according to an exemplary embodiment of the present disclosure.

Referring to FIG. 6, the apparatus for providing the travel information may obtain the conversation history (S610). The conversation history may include one or more of the common conversation history and the individual conversation history.

The apparatus for providing the travel information may store the conversation history (S620). The apparatus for providing the travel information may store the conversation history by classifying the conversation history for each user.

The apparatus for providing the travel information may be configured to generate the travel information (S630). The apparatus for providing the travel information may be configured to generate the travel information by using one or more language models, based on the conversation history.

The apparatus for providing the travel information may output the travel information (S640). For example, the apparatus for providing the travel information may output the travel information by using the terminal. As an exemplary embodiment of the present disclosure, the apparatus for providing the travel information may output travel information by using the mobile devices.

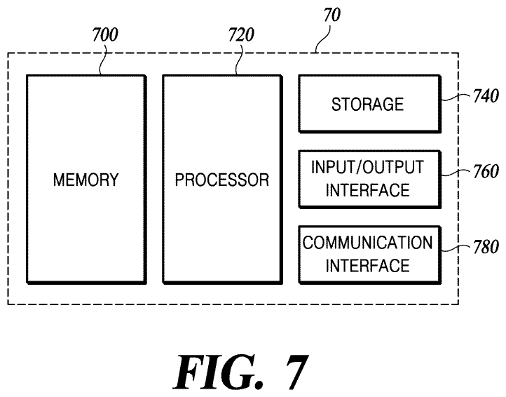

FIG. 7 is a block diagram schematically illustrating an exemplary computing device that may be used to implement the apparatus and the method which are described in an exemplary embodiment of the present disclosure.

The computing device 70 may include some or all of the memory 700, the processor 720, the storage 740, the input/output interface 760, and the communication interface 780. The computing device 70 may be not only a stationary computing device such as a desktop computer and a server, but also a mobile computing device such as a laptop computer and a smartphone. The computing device 70 may include any specialized hardware accelerator configured for efficiently processing operations for an artificial intelligence model. For example, the computing device 70 may include a graphic processing unit (GPU), a tensor processing unit (TPU), or a neural processing unit (NPU).

The memory 700 may store a program that causes the processor 720 to perform a method or an operation according to various embodiments of the present disclosure. For example, the program may include a plurality of commands executable by the processor 720, and the method or the operation may be performed by causing the processor 720 to execute the plurality of commands. The memory 700 may be a single memory or a plurality of memories. In the instant case, information required for performing the method or the operation according to various embodiments of the present disclosure may be stored in a single memory, or may be divided and stored in the plurality of memories. When the memory 700 includes the plurality of memories, the plurality of memories may be physically separated. The memory 700 may include at least one of a volatile memory and a nonvolatile memory. The volatile memory includes a static random access memory (SRAM) or a dynamic random access memory (DRAM), and the nonvolatile memory includes a flash memory.

The processor 720 may include at least one core configured for executing at least one command. The processor 720 may execute the commands stored in the memory 700. The processor 720 may be a single processor or a plurality of processors.

The storage 740 maintains stored data even when power to the computing device 70 is cut off. For example, the storage 740 may include a non-volatile memory, and may include a storage medium such as a magnetic tape, an optical disk, and a magnetic disk. A program stored in the storage 740 may be loaded into the memory 700 before being executed by the processor 720. The storage 740 may store a file written in a program language, and a program generated from a file by a compiler or the like may be loaded into the memory 700. The storage 740 may store data to be processed by the processor 720 and/or data processed by the processor 720.

The input/output interface 760 may provide an interface with an input device such as a keyboard and a mouse and/or an output device such as a display device and a printer. A user may trigger execution of a program in the processor 720 through the input device and/or may confirm a processing result of the processor 720 through the output device.

The communication interface 780 may provide access to an external network. The computing device 70 may communicate with other devices through the communication interface 780.

The components described in the exemplary embodiments of the present disclosure may be achieved by hardware components including at least one of Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the steps described in the exemplary embodiments of the present disclosure may be achieved by software that may be recorded on a recording medium. At least some of the components, functions, and steps described in the exemplary embodiments of the present disclosure may be achieved by a combination of hardware and software.

The method according to exemplary embodiments of the present disclosure may be written as a program that can be executed in a computer and may be implemented using various recording media, such as magnetic storage media, optical readout media, digital storage media, etc.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium), or a radio signal, for processing by, or controlling the operation of, a data processing device, e.g., a programmable processor, a computer, or a plurality of computers. A computer program, such as the computer program(s) described above, may be written in any form of programming language, including compiled or interpreted languages and may be deployed in any form, including as a stand-alone program or as modules, components, subroutines, or other units suitable for use in a determining environment. The computer program may be deployed to be processed on a computer or computers at a single site, or distributed across multiple sites and interconnected by a communication network.

Processors suitable for processing computer programs include, for example, both general-purpose and special-purpose microprocessors, and any one or more processors of any type of digital computer. Generally, the processor will receive instructions and data from read-only memory or random access memory, or both. Elements of the computer may include at least one processor executing instructions and one or more memory devices storing instructions and data. In general, the computer may include one or more mass storage devices, such as magnetic, magneto-optical, or optical disks, that store data, or may be coupled to receive data from them, transmit data to them, or both. Information carriers suitable for embodying computer program instructions and data include, for example, semiconductor memory devices, e.g., hard disks, magnetic media such as floppy disks and magnetic tapes, optical media such as compact disk read only memory (CD-ROM) and digital video disks (DVDs), magneto-optical media such as floptical disks, read only memory (ROM), random access memory (RAM), flash memory, erasable programmable ROM (EPROM), electrically erasable programmable ROM (EEPROM), and the like. The processor and memory may be supplemented by or include special-purpose logic circuitry.

The processor may perform an operating system and software applications executed on the operating system. The processor device may also access, store, manipulate, process, and generate data in response to the execution of the software. For ease of understanding, a processor device is sometimes described as utilizing a single processing element, but one of ordinary skill in the art will recognize that a processor device may include a plurality of processing elements and/or a plurality of types of processing elements. For example, a processor device may include a plurality of processors or one processor and one controller. Other processing configurations, such as a parallel processor, can be used.

Furthermore, the non-transitory computer-readable media may be any available medium that can be accessed by a computer and may include both computer storage media and transmission media.

While the present specification includes details of some specific implementations, they should not be understood as limiting the scope of any invention or claimed subject matter, but rather as a description of features that may be peculiar to a particular embodiment of a particular invention. Certain features described herein in the context of individual embodiments may be implemented in combination in a single embodiment. Conversely, various features described in the context of a single embodiment may also be implemented in a plurality of embodiments, either individually or in any suitable sub-combination. Furthermore, while features may operate in a particular combination and be initially described literally as claimed, one or more features of the claimed combination may be excluded from the claimed combination in some instances, and the claimed combination may be changed to a sub-combination or variation of the sub-combination.

Similarly, although the drawings depict operations in a particular order, it should not be understood that such operations must be performed in the particular or sequential order depicted or that all depicted operations must be performed to achieve a desired result. In certain cases, multitasking and parallel processing may be advantageous. Furthermore, the separation of the various device components in the exemplary embodiments described above should not be understood to require such separation in all embodiments, and it should be understood that the program components and devices described may generally be integrated into a single software product or packaged in multiple software products.

According to an exemplary embodiment of the present disclosure, a customized travel guide may be provided to users so that travel information generated based on a common conversation history obtained from users located inside vehicles is output to the users by using terminals disposed in the vehicles.

According to an exemplary embodiment of the present disclosure, a customized travel guide may be provided to users so that travel information generated based on common conversation history obtained from users located inside vehicles is output to the respective users by using mobile devices possessed by the respective users.

According to an exemplary embodiment of the present disclosure, a travel guide may be continuously provided to users so that travel information generated based on common conversation history obtained from users who have boarded a vehicle is output to each user using a mobile device possessed by each user even after the users have gotten out of the vehicle, thereby continuously providing.

According to an exemplary embodiment of the present disclosure, travel information provided to a user inside a vehicle may be continuously provided outside the vehicle. In the present manner, a vehicle-based service may be naturally shifted to a mobile-based service.

According to an exemplary embodiment of the present disclosure, user-specific travel information generated based on common conversation history obtained from users located inside a vehicle and individual conversation history obtained from respective users who are not located inside the vehicle is output to the respective users by using mobile devices possessed by the respective users even after the users leave the vehicle.

The effects of the present disclosure are not limited to those mentioned above, and other effects not mentioned will be apparent to those of ordinary skill in the art from the above description.

On the other hand, the exemplary embodiments of the present disclosure presented by the specification and drawings are merely specific examples for clarity and are not intended to limit the scope of the present disclosure. It should be clear to those of ordinary skill in the art that, besides the exemplary embodiments disclosed herein, modifications thereto can be made within the scope of the present disclosure.

The scope of protection of the present disclosure is to be construed by the following claims, and all equivalent technical ideas within the scope thereof are to be construed as being included in the scope of the present disclosure.

What is claimed is:

1. A method, comprising:
obtaining conversation history of users;
storing the conversation history by classifying the conversation history for each user;
generating travel information by using one or more language models, based on the conversation history; and
outputting the travel information.

2. The method of claim 1, wherein the conversation history includes at least one of common conversation history or individual conversation history.

3. The method of claim 2, wherein the common conversation history is conversation history obtained based on that the users are located inside a vehicle, and the individual conversation history is conversation history obtained based on that the users are located outside the vehicle.

4. The method of claim 2, wherein the common conversation history is obtained by using a terminal disposed in the vehicle, and the individual conversation history is obtained by using each of mobile devices possessed by the users.

5. The method of claim 2, wherein the storing of the conversation history by classifying the conversation history for each user includes:
equally storing the common conversation history in respective storage spaces allocated to the respective users, and storing the individual conversation history only in a storage space allocated to the user generating the individual conversation history.

6. The method of claim 2,
wherein the obtaining of the conversation history includes obtaining the common conversation history from a terminal disposed in vehicle,
wherein the storing of the conversation history by classifying the conversation history for each user includes equally storing the common conversation history in respective storage spaces allocated to the respective users,
wherein the generating of the travel information includes generating the travel information, based on the common conversation history, and
wherein the outputting of the travel information includes outputting the travel information by using the terminal.

7. The method of claim 2,
wherein the obtaining of the conversation history includes obtaining the common conversation history from a terminal disposed in the vehicle,
wherein the storing of the conversation history by classifying the conversation history for each user includes equally storing the common conversation history in respective storage spaces allocated to the respective users,
wherein the generating of the travel information includes generating the travel information, based on the common conversation history, and
wherein the outputting of the travel information includes outputting the travel information by using respective mobile devices possessed by the users.

8. The method of claim 2,
wherein the obtaining of the conversation history includes obtaining the common conversation history from a terminal disposed in the vehicle, and obtaining the individual conversation history from each of mobile devices possessed by the users,
wherein the storing of the conversation history by classifying the conversation history for each user includes equally storing the common conversation history in respective storage spaces allocated to the respective users, and storing the individual conversation history only in a storage space allocated to the user generating the individual conversation history, out of the storage spaces allocated to the respective users, based on the user generating the individual conversation history,
wherein the generating of the travel information includes generating the travel information for the respective users, based on the common conversation history and the individual conversation history, and
wherein the outputting of the travel information includes outputting the travel information for the respective users by using the respective mobile devices.

9. The method of claim 2, wherein the travel information is differently generated for the respective users.

10. A non-transitory computer readable storage medium on which a program for performing the method of claim 1 is recorded.

11. An apparatus for providing travel information, the apparatus comprising:
at least one memory storing commands; and
at least one processor operatively connected to the at least one memory,
wherein the at least one processor, by executing the commands:
obtains conversation history of users,
store the conversation history by classifying the conversation history for each user,
generate travel information by using one or more language models, based on the conversation history, and
output the travel information.

12. The apparatus of claim 11, wherein the conversation history includes at least one of common conversation history or individual conversation history.

13. The apparatus of claim 12, wherein the common conversation history is conversation history obtained based on that the users are located inside a vehicle, and the individual conversation history is conversation history obtained based on that the users are located outside the vehicle.

14. The apparatus of claim 12, wherein the common conversation history is obtained by using a terminal disposed in the vehicle, and the individual conversation history is obtained by using each of mobile devices possessed by the users.

15. The apparatus of claim 12, wherein the storing of the conversation history by classifying the conversation history for each user includes equally storing the common conversation history in respective storage spaces allocated to the respective users, and storing the individual conversation history only in a storage space allocated to the user generating the individual conversation history.

16. The apparatus of claim 12,
wherein the obtaining of the conversation history includes obtaining the common conversation history from a terminal disposed in vehicle,
wherein the storing of the conversation history by classifying the conversation history for each user includes equally storing the common conversation history in respective storage spaces allocated to the respective users,
wherein the generating of the travel information includes generating the travel information, based on the common conversation history, and
wherein the outputting of the travel information includes outputting the travel information by using the terminal.

17. The apparatus of claim 12,
wherein the obtaining of the conversation history includes obtaining the common conversation history from a terminal disposed in the vehicle,
wherein the storing of the conversation history by classifying the conversation history for each user includes equally storing the common conversation history in respective storage spaces allocated to the respective users,
wherein the generating of the travel information includes generating the travel information, based on the common conversation history, and
wherein the outputting of the travel information includes outputting the travel information by using respective mobile devices possessed by the users.

18. The apparatus of claim 12,
wherein the obtaining of the conversation history includes obtaining the common conversation history from a terminal disposed in the vehicle, and obtaining the individual conversation history from respective mobile devices possessed by the users,
wherein the storing of the conversation history by classifying the conversation history for each user includes equally storing the common conversation history in respective storage spaces allocated to the respective users, and storing the individual conversation history only in a storage space allocated to the user generating the individual conversation history, out of the storage spaces allocated to the respective users, based on the user generating the individual conversation history,
wherein the generating of the travel information includes generating the travel information for the respective users, based on the common conversation history and the individual conversation history, and
wherein the outputting of the travel information includes outputting the travel information for the respective users by using the respective mobile devices.

19. The apparatus of claim 18, wherein the travel information is differently generated for the respective users.
